(19) United States
(12) Patent Application Publication
(10) Pub. No.: US 2020/0095393 A1
(43) Pub. Date: Mar. 26, 2020

(54) ORGANIC AEROGELS BASED ON AMINES AND CYCLIC ETHER POLYMER NETWORKS

(71) Applicants: Henkel AG & Co. KGaA, Duesseldorf (DE); Henkel IP & Holding GmbH, Duesseldorf (DE)

(72) Inventors: Mariola Calle De Celis, Palencia (ES); Elisabeth Torres Cano, Barcelona (ES); Fouad Salhi, Farmington, CT (US); Parfait Jean Marie Likibi, Mount Pleasant, SC (US); Ilaria De Santo, Naples (IT); Belen Del Saz-Orozco, Las Rozas de Madrid (ES); Asta Sakalyte, Sant Salvador (Tarragona) (ES)

(21) Appl. No.: 16/594,121

(22) Filed: Oct. 7, 2019

Related U.S. Application Data
(63) Continuation of application No. PCT/EP2018/057474, filed on Mar. 23, 2018.

(30) Foreign Application Priority Data
Apr. 6, 2017 (EP) 17165274.6

(51) Int. Cl. C08J 9/28; C08J 9/00

(52) U.S. Cl. CPC C08J 9/28; C08J 9/0028; C08J 2379/02; C08J 2201/0482; C08J 2363/00; C08J 2205/026

(57) ABSTRACT

The present invention relates to an organic aerogel obtained by reacting an amine compound having at least two amine functionalities and a cyclic ether compound in the presence of a solvent. An organic aerogel according to the present invention is produced with a versatile process and provides good thermal and acoustic insulation and good mechanical properties.

### TECHNICAL FIELD

The present invention relates to an organic aerogel obtained by reacting an amine compound having at least two amine functionalities and a cyclic ether compound in the presence of a solvent. An organic aerogel according to the present invention is produced with a versatile process and provides good thermal insulation and good mechanical properties.

### BACKGROUND OF THE INVENTION

Aerogels are three-dimensional, low-density assemblies of nanoparticles derived from drying wet-gels by exchanging the pore-filling solvent to a gas, usually with a supercritical fluid. By these means, the capillary forces exerted by the solvent due to evaporation are minimized, and structures with large internal void space are achieved. The high porosity and small pore size of these materials is the reason for their very low thermal conductivity, which makes aerogels extremely attractive materials for thermal insulating applications.

Compared to common thermal insulators in the market, aerogels are lightweight materials with a very low thermal conductivity. Therefore, aerogels are known for being good insulating materials due to their nanostructure and the elimination of any contribution from the gas phase. Thus, thickness of the insulating layer can be reduced while obtaining similar insulating properties. Aerogels are environmentally friendly because they are air filled, and furthermore, they are not subject to ageing.

Thermal insulation is important in many different applications in order to save energy and reduce costs. Examples of such applications are construction, transport and industry. For some applications, it is possible to use a thick insulating panel to reduce the heat transfer. However, other applications may require thinner insulating panels/layers because of size limitations. For the thin insulating panels/layers the thermal conductivity of the material has to be extremely low in order to get the same insulating properties than with thicker insulating panels/layers. Additionally, in some cases and depending on the application, high mechanical properties may also be required.

Silica based inorganic aerogels (Si—O—Si) provide low value of thermal conductivity in the range 10-30 mW m⁻¹ K⁻¹ as well as low densities. This makes them a primary choice for thermal insulation applications. However, silica aerogels have disadvantages like being fragile, unable to withstand mechanical stress and being classified as hazardous breathable materials due to their dusty nature.

To improve the strength of silica aerogels, an organic component is incorporated into the (Si—O—Si) structure. Such polyurea, polystyrene, polyimide, polyacrylate reinforced inorganic silica aerogels are known. An additional step in their production due to incorporation of the organic component is however undesirable. Further issues involve increased densities and higher thermal conductivities compared to the neat silica aerogels. Additionally, the dustiness is not completely suppressed.

Purely organic aerogels offer promise as robust, dust-free and ultra-light weight materials. These can be used in thermal insulation due to their low thermal conductivities and usually better mechanical properties.

Different polymeric networks have been described for the preparation of purely organic aerogels. Aerogel based on resorcinol-formaldehyde networks are brittle and their curing process takes a long time (up to 5 days), which results in a drawback for industrial scale production. On the other hand, organic aerogels based on isocyanate groups have faster curing process and their mechanical properties can be modified depending on the reacting functional group with the isocyanate moiety, as well as the monomer and/or oligomer chemical structure (i.e. number of functionalities, aromatic or aliphatic nature, steric hindrance, etc.).

Prior art discloses a wide variety of aerogels based on isocyanate chemistry. Isocyanate moieties have been reacted with hydroxylated compounds to obtain polyurethane aerogels; with amines or water to obtain polyurea aerogels; with anhydrides to obtain polyimide aerogels; and with carboxylic acids to obtain polyamide aerogels. In most of the cases, multifunctional monomers must be used to increase the cross-linking degree, which usually results in higher mechanical properties. The trimerization of isocyanate groups to form polymeric isocyanurate networks has also been described.

Silica aerogels incorporating epoxy-amine framework are available in the art. They are either produced by cross-linking amine modified silica aerogels with epoxy components or analogously by cross-linking epoxy modified silica aerogels with an amine compound. Such aerogels provide increased robustness but suffer from increased thermal conductivities too. Recently reports show the development of modified hybrid silica aerogels containing non-polymeric, functional organic materials covalently bonded to the silica network of the aerogel. These materials presented low thermal conductivity, good mechanical strength and lower weight compared to neat silica aerogels. However, an additional step for the synthesis of the organic-inorganic precursor was needed. On the other hand, polymer/clay aerogel composites were prepared from water soluble epoxy/amine precursors reacting within a clay hydrogel. The compressive properties of these polymer/clay aerogel composites greatly exceed those of plain clay aerogels.

Therefore, purely organic aerogels are desired to overcome most of the drawbacks observed for the hybrid counterparts and for purely silica-based inorganic aerogels. Thus there is still a need for organic aerogels that are robust, mechanically stable and do not shed dust.

### SUMMARY OF THE INVENTION

The present invention relates to an organic aerogel obtained by reacting an amine compound having at least two amine functionalities and a cyclic ether compound in the presence of a solvent.

The present invention also relates to method for preparing an organic aerogel comprising the steps of: 1) dissolving a cyclic ether compound into a solvent and adding an amine compound and mixing; 2) adding a catalyst, if needed, and mixing; 3) transferring the mixture of step (2) to a sealed mold; 4) heating or maintaining the solution in order to form a gel; 5) washing said gel with a solvent; 6) optionally, adding a silylation agent to the wet gel from step (5) and after reaction completion washing the gel with acetone; 7) drying said gel by a) supercritical drying or b) ambient drying, wherein, optionally, the CO₂ from the supercritical drying is recycled.

The present invention also encompasses a thermal insulating material or an acoustic material comprising an organic aerogel according to the present invention.

In addition, the present invention encompasses, use of an organic aerogel according to the present invention as a thermal insulating material or acoustic material.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

All percentages, parts, proportions and then like mentioned herein are based on weight unless otherwise indicated.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in disclosing the invention, including technical and scientific terms, have the meaning as commonly understood by one of the ordinary skill in the art to which this invention belongs to. By means of further guidance, term definitions are included to better appreciate the teaching of the present invention.

The present invention relates to the development of organic aerogels based on a polymeric network formed by reaction of polyamine monomer or oligomers and cyclic ether groups in the presence of a solvent and with or without a catalyst. These groups can react with each other by different mechanisms to obtain a highly cross-linked polymeric network, which gels in presence of a solvent. After drying in supercritical or ambient conditions, lightweight aerogels are obtained with pore sizes in the range of tens to hundreds of nanometres. The aerogels thus obtained exhibit low thermal conductivity and density values, are mechanically robust and dust-free. The properties of the aerogels can be adapted by altering the reaction conditions and starting materials, resulting in a very versatile production process.

The present invention relates to an organic aerogel obtained by reacting an amine compound having at least two amine functionalities and a cyclic ether compound in the presence of a solvent.

By the term ‘aerogel’ is meant herein a synthetic porous, low-density material derived from a gel, in which a gas has replaced the liquid component of the gel. Due to their porosity and density, these materials generally present low thermal conductivity.

By the term ‘gel’ is meant herein is a solid, jelly-like soft material, having a substantially dilute cross-linked system, which exhibits no flow when in the steady state.

The approach of the present invention involves the preparation of organic aerogels based on amine-cyclic ether polymer networks. For this purpose, polyamine monomers or oligomers were reacted with epoxy resins resulting in a polymeric 3D aerogel network with high cross-linking degree. Epoxy groups can react with amines, phenols, mercaptans, isocyanates or acids. However, amines are the most commonly used curing agents for epoxides.

In the preparation of such aerogel materials, the amines react with the epoxy group through the active amine hydrogen, via step-growth polymerization. Each primary amine group is theoretically capable of reacting with two epoxide groups, and each secondary amine group is capable of reacting with one epoxide group. Usually, when the concentration of epoxy groups is equal to or lower than the concentration of NH groups, side reactions do not take place.

Hydroxyl groups catalyze the reaction, facilitating the nucleophilic attack of the amino group to the epoxy ring. As secondary alcohols are continuously generated, epoxy-amine reactions are autocatalyzed. Theoretically, the hydroxyls formed should be also capable of reacting with the epoxy groups to form an ether linkage. This reaction is often catalyzed by tertiary amines. However, the tertiary amine formed by the epoxy-secondary amine reaction is apparently too immobile and sterically hindered to act as a catalyst.

Scheme 1 shows the possible reactions of a) primary amine compounds and b) secondary amine compounds with epoxy compounds and the possible side reaction of c) hydroxyl group with epoxy compounds.

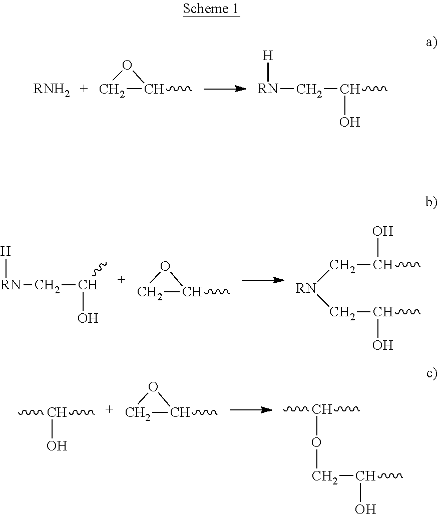

The resulting nanoporous aerogel network is mainly based on a polyamine structure. The presence of ether linkages could be also possible but to a much lesser extent.

In one embodiment, an organic aerogel is obtained by reacting an amine compound having at least two amine functionalities and a cyclic ether compound in the presence of a solvent.

In another embodiment, an organic aerogel is obtained by reacting an amine compound having at least two amine functionalities and a cyclic ether compound in the presence of a solvent and a catalyst.

In yet another embodiment, an organic aerogel is obtained by reacting an amine compound having at least two amine functionalities and a cyclic ether compound in the presence of a solvent and a catalyst, further reacting the organic aerogel with a silylation agent.

An organic aerogel according to the present invention is obtained by reacting an amine compound having at least two amine functionalities and a cyclic ether compound in the presence of a solvent.

Preferably the amine compound for use in the present invention has at least one primary amine functionality and a total amine functionality equal or greater than 2. More preferably, said amine compound has a functionality from 2 to 10, and even more preferably functionality from 2 to 4. By the term ‘functionality’ is meant herein number of amine groups in the compound.

Suitable amine compounds for the present invention are aliphatic amine compounds or cycloaliphatic amine compounds or aromatic amine compounds or oligomeric polyamine compounds. Preferred amine compounds are the aliphatic amine compounds.

Examples of suitable amine compounds (1)-(8) are

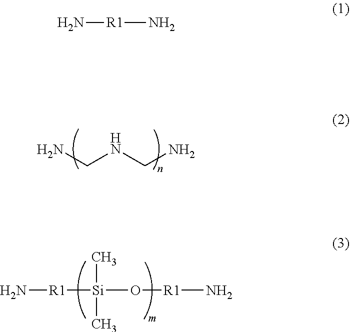

wherein R1 is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination thereof; n is an integer from 1 to 30, preferably from 1 to 15, more preferably from 1 to 6, and even more preferably from 1 to 4; and m is an integer from 1 to 30, preferably from 1 to 15, more preferably from 1 to 6, and even more preferably from 1 to 4;
or

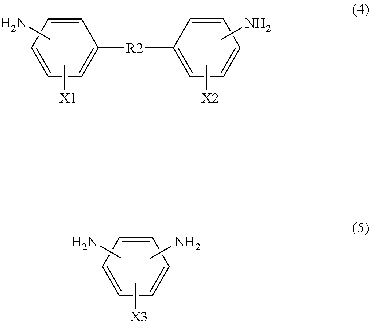

wherein R2 is selected from the group consisting of —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted C3-C30 heterocycloalkyl group and a substituted or unsubstituted C1-C30 heteroalkyl group and a combination thereof; X1, X2 and X3 are same or different substituents and are selected independently from the group consisting of hydrogen, halogen, alkoxy and linear and branched C1-C6 alkyl groups;
or

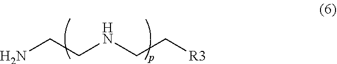

wherein R3 is —Si(OC_{z}H_{2z+1})₃, wherein z is an integer from 1 to 6; and p is an integer from 1 to 30, preferably from 1 to 15, more preferably from 1 to 6, and even more preferably from 1 to 4;
or

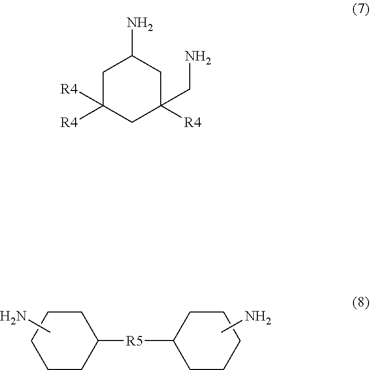

wherein R4 is selected from the group consisting of linear and branched C1-C6 alkyl groups; R5 is selected from the group consisting of —O—, S, —C(O)—, —S(O)₂—, —S(PO₃)—, substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof.

Preferably, the amine compound is selected from the group consisting of N-isopropyl-ethylenediamine, 1,5-diamino-2-methylpentane, 1,3-diamino-2-propanol, 3,3′-diamino-N-methyldipropylamine, 1,3-diamino-N-(2-hydroxyethyl)propane, 1,4-diaminobutane, 1,6-diaminohexane, 1,8-diaminooctane, 3-(methylamino)propylamine, ethylenediamine, diethylenetriamine, N-aminoethylpiperazine, aminoethylethanolamine, 1,3-bis(3-aminopropyl)-1,1,3,3-tetramethyldisiloxane, N-[3-(trimethoxysilyl)propyl]ethylenediamine, N-(3-trimethoxysilylpropyl)diethylenetriamine, N-cyclohexyl-1,3-propanediamine, 1,3-diaminopropane, triethylenetetramine, tetraethylenepentamine, poly(dimethylsiloxane) aminopropyl terminated, polyetheramines containing ethylene glycol and diethylene glycol and mixtures thereof.

More preferably the amine compound is selected from the group consisting of 1,3-diaminopropane, triethylenetetramine, tetraethylenepentamine and mixtures thereof. These amine compounds are preferred because they provide a good compromise between thermal conductivity and mechanical properties.

Suitable commercially available amine compounds for use in the present invention include, but not limited to aliphatic polyamines such as N-isopropyl-ethylenediamine, 1,5-diamino-2-methylpentane, 1,3-diamino-2-propanol, 3,3′-diamino-N-methyldipropylamine, 1,3-diamino-N-(2-hydroxyethyl)propane, 1,4-diaminobutane, 1,6-diaminohexane, 1,8-diaminooctane, 3-(methylamino)propylamine, ethylenediamine, diethylenetriamine, tetraethylenepentamine, N-aminoethylpiperazine, aminoethylethanolamine, 1,3-bis(3-aminopropyl)-1,1,3,3-tetramethyldisiloxane, N-[3-(trimethoxysilyl)propyl]ethylenediamine, N-(3-trimethoxysilylpropyl)diethylenetriamine and N-cyclohexyl-1,3-propanediamine from Aldrich; 1,3-diaminopropane, triethylenetetramine from Merck; poly(dimethylsiloxane) aminopropyl terminated, polyetheramines containing ethylene glycol and diethylene glycol (such as Jeffamine™ diamines) and Priamine 1071 from Croda.

Cycloaliphatic amines such as bis(4-aminocyclohexyl)methane, diaminocyclohexane, 3-aminomethyl-3,5,5-trimethylcyclohexylamine from Aldrich.

Aromatic amines such as methylene dianiline, m-phenylene diamine, diaminophenyl sulfone, 2,2-bis(3-amino-hydroxyphenyl)hexafluoropropane, melamine from Aldrich.

Preferably the amine compound is present in the reaction mixture from 0.5 to 7% by weight of the total reaction mixture including the solvent, preferably from 0.5 to 5% and more preferably from 0.5 to 3%.

Addition of the amine compound less than 0.5% by weight of the total reaction mixture, including the solvent may not lead to the formation of organic aerogel according to the present invention, while more than 7% may lead to organic aerogels with deteriorated properties.

An organic aerogel according to the present invention is obtained by reacting an amine compound having at least two amine functionalities and a cyclic ether compound in the presence of a solvent.

Suitable cyclic ether compound for use in the present invention has a functionality equal or greater than 2. Preferably said cyclic ether compound has a functionality from 2 to 10, and more preferably from 3 to 4. By the term ‘functionality’ is meant herein number of cyclic ether groups in the compound.

The cyclic ether compound for use in the present invention is an epoxy compound or an oxetane compound, more preferably an epoxy compound.

Epoxy compounds are preferred cyclic ethers for obtaining organic aerogels as per the present invention since they offer a good compromise between thermal conductivity and mechanical properties.

When the cyclic ether compound used in the present invention is an epoxy compound, the epoxy compound has a functionality from 2 to 10, preferably from 3 to 4. By the term ‘functionality’ is meant herein number of epoxy groups in the compound.

Examples of suitable epoxy compounds (9)-(20) are:

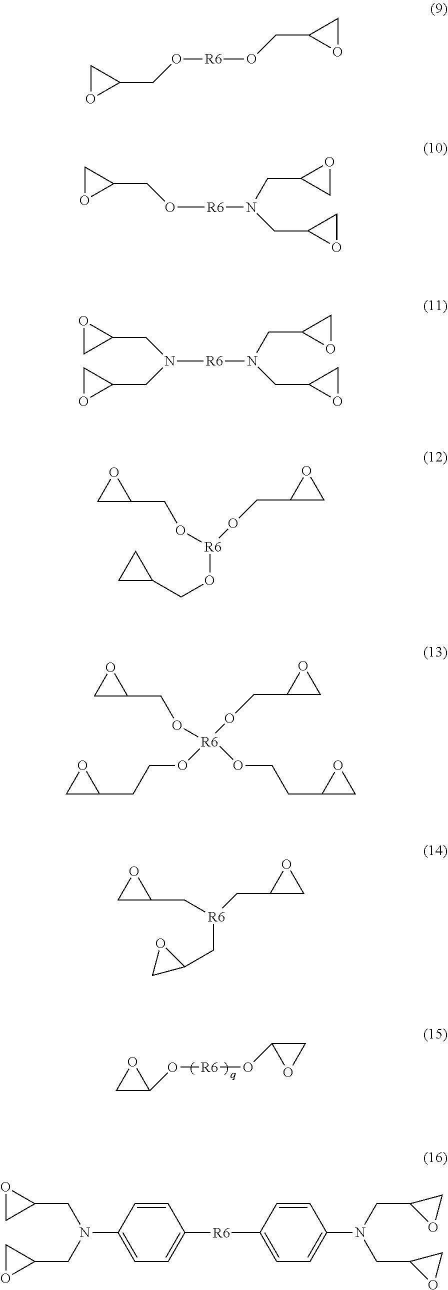

wherein R6 is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination thereof; and q is an integer from 1 to 30;
or

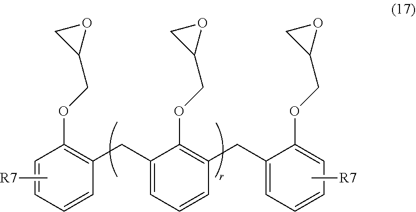

wherein R7 is selected independently from the group consisting of hydrogen, halogen, alkyl and alkenyl; and r is an integer from 1 to 10;
or

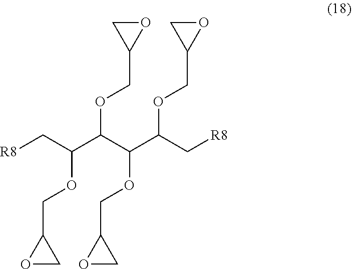

wherein R8 is selected independently from the group consisting of hydrogen, hydroxyl, halogen, alkyl and alkenyl;
or

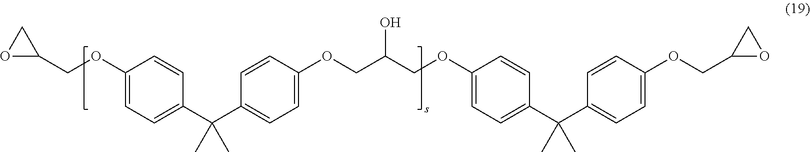

wherein s is an integer from 0 to 16;
or

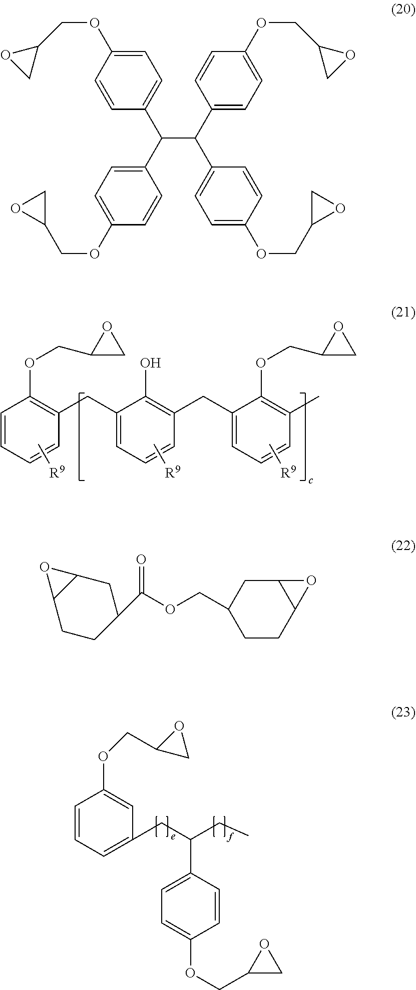

wherein R⁹ represents a substituent or different substituents and is selected independently from a group consisting of hydrogen, halogen and linear or branched C1-C15 alkyl or alkenyl groups, attached to their respective phenyl ring at the 3-, 4- or 5-position and their respective isomers and c is an integer from 1 to 5; wherein e and f are integers from 1 to 10;

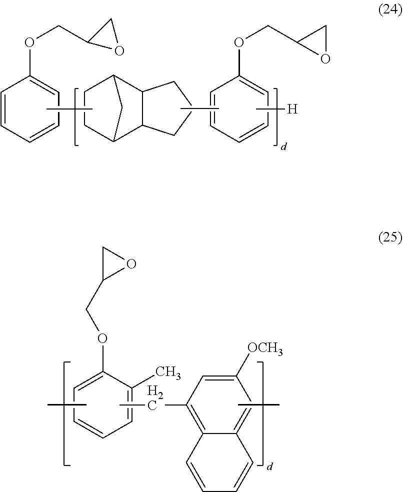

wherein d is an integer from 1 to 5;

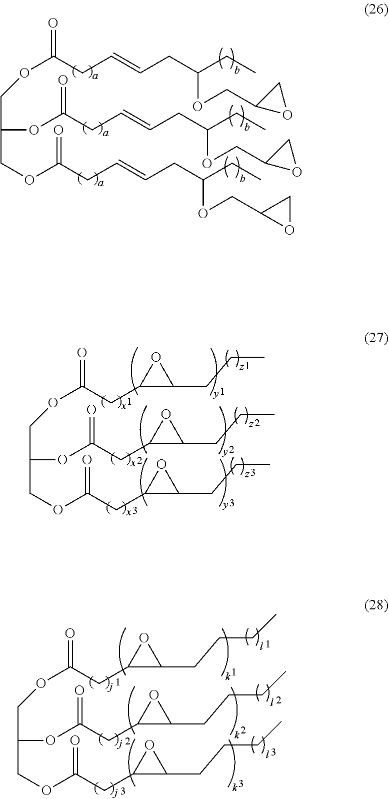

wherein a and b independently are from 1 to 12; wherein x¹, x², x³ are independently from 1 to 26 y¹, y², y³ are independently from 0 to 6, provided y¹+y²+y³ is at least 2 and z¹, z², z³ are independently from 0 to 25; wherein j¹, j², j³ are independently from 1 to 26 k¹, k², k³ are independently from 0 to 6, provided k¹+k²+k³ is at least 2 and l¹, l², l³ are independently from 0 to 25.

In a preferred embodiment compounds represented by formulae (27) or (28) may not have more than 28 carbon atoms in an individual chain, for e.g. in the chain containing x¹, y¹ and z¹, starting from the carbon of the carbonyl x¹, y¹ and z¹ have values such that the chain has no more than 28 carbon atoms.

Preferably, the epoxy compound is selected from the group consisting of N,N-diglycidyl-4-glycidyloxyaniline, 4,4′-methylene bis(N,N-diglycidylaniline), 1,4 butanediol diglycidyl ether, cyclohexandimethanol diglycidyl ether, ethylene glycol diglycidyl ether, dipropylen glycol diglycidyl ether, 1,6 hexanediol diglycidyl ether, trimethylolpropane triglycidyl ether, polyglycerol-3-polyglycidyl ether, polyglycerol-3-polyglycidyl ether, sorbitol glycidyl ether-aliphatic polyfunctional epoxy resin, phenol novolac epoxy resins, tetraglycidyl ether of 1,1,2,2-tetrakis(hydroxyphenyl)ethane, N,N,N′,N′-tetraglycidyl-4,4′-methylenebisbenzenamine, tris-(hydroxyl phenyl) methane-based epoxy resin, triglicidyl ether of meta-aminophenol, triglicidyl ether of para-aminophenol, bisphenol-A based epoxy resins, phenol novolac epoxy resins, bisphenol-A based epoxy resins, polypropylene glycol epoxy, phenol novolac epoxy resins and mixtures thereof.

More preferably the epoxy compound is selected from the group consisting of N,N-diglycidyl-4-glycidyloxyaniline, 4,4′-methylene bis(N,N-diglycidylaniline) and mixtures thereof. These epoxy compounds are preferred because they provide a good compromise between thermal conductivity and mechanical properties.

Suitable commercially available epoxy compounds for use in the present invention include, but not limited to 1,4 butanediol diglycidyl ether (Erisys™ GE21), cyclohexandimethanol diglycidyl ether (Erisys™ GE22), ethylene glycol diglycidyl ether (Erisys™ EDGE), dipropylen glycol diglycidyl ether (Erisys™ GE23), 1,6 hexanediol diglycidyl ether (Erisys™ GE25), trimethylolpropane triglycidyl ether (Erisys™ GE30), polyglycerol-3-polyglycidyl ether (Erisys™ GE38), polyglycerol-3-polyglycidyl ether (Erisys™ GE38), sorbitol glycidyl ether-aliphatic polyfunctional epoxy resin (Erisys™ GE60), phenol novolac epoxy resins (Epalloy™ 8220, 8230, 8240, 8250, 8280, 8330, 8350, 8370) from CVC Thermoset resins; tetraglycidyl ether of 1,1,2,2-tetrakis(hydroxyphenyl)ethane (Araldite® XB-4399-3), N,N,N′,N′-Tetraglycidyl-4,4′-methylenebisbenzenamine (Araldite® MY720), tris-(hydroxyl phenyl) methane-based epoxy resin (Tactix® 742), triglicidyl ether of meta-aminophenol (Araldite® MY0610, MY0600), triglicidyl ether of para-aminophenol (Araldite® MY0510, MY0500), bisphenol-A based epoxy resins (Araldite® GY6004, GY6005, GY9513, GY9580, GY9613, GY9615, GT6243, GT4248, GT6097, GT7072, Tactix® 123) and phenol novolac epoxy resins (Araldite EPN 1179, 1180) and Araldite® CY5622 from Huntsman; bisphenol-A based epoxy resins (D.E.R.™ 317, 330, 331, 332, 337, 362, 383) and polypropylene glycol epoxy (D.E.R.™ 732, 736), phenol novolac epoxy resins (D.E.N.™ 425, 431, 438, 439, 440) from Dow Chemical, Cardolite (NC-547, NC-514 and NC-514S) from Cardolite, Epiclon (HP-5000, HP7200H and HP-9500) from DIC Corporation, castor oil triglycidyl ether (Erisys GE35) from CVC thermoset, CER 4221 from DKSH and epoxidized palm oil, Vikoflex (7170 and 7190) from Arkema.

The epoxy compound is present in the reaction mixture from 2 to 40% by weight of the total reaction mixture including the solvent, preferably from 3 to 30%, more preferably from 4 to 20% and even more preferably from 5 to 10%.

Addition of the epoxy compound less than 2% by weight of the total reaction mixture including the solvent may not lead to the formation of organic aerogel according to the present invention, while more than 40% may lead to organic aerogels with deteriorated properties.

Suitable oxetane compound for use in the present invention is selected from the group consisting of

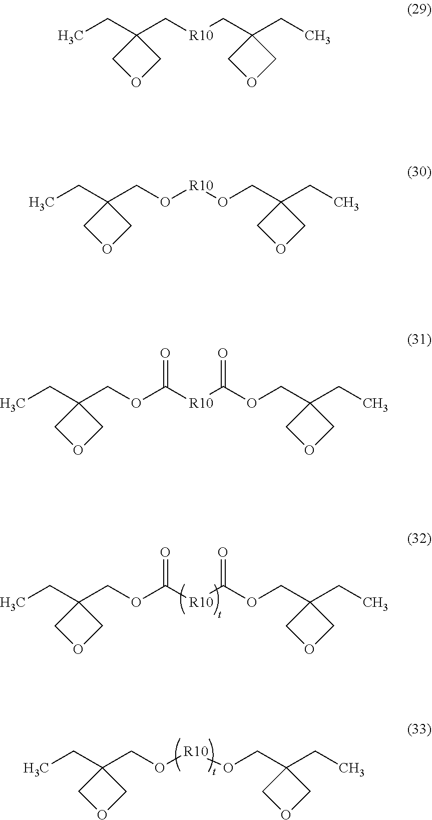

wherein R10 is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group; and t is an integer from 1 to 30.

Preferably, oxetane compound is selected from the group consisting of 1,4-bis[(3-ethyl-3-oxetanylmethoxy)methyl]benzene and bis[1-ethyl(3-oxetanyl)]methyl ether. These oxetane compounds are preferred because they provide a good compromise between thermal conductivity and mechanical properties.

Suitable commercially available oxetane compound for use in the present invention include, but not limited to 1,4-bis[(3-ethyl-3-oxetanylmethoxy)methyl]benzene (Eternacoll OXBP), bis[(3-ethyl-3-oxetanyl)methyl]terephthalate (Eternacoll OXTP), bis[1-ethyl(3-oxetanyl)]methyl ether (Aron OXT 221), and 1,4-bis[(3-ethyl-3-oxetanylmethoxy) methyl]benzene (Aron OXT 121) from Toagosei America INC.

It has been surprisingly found out that low thermal conductivity and good mechanical properties can be provided when a ratio of amine/cyclic ether groups is 8:1, preferably 3:1 and more preferably 1:1. For high amine/cyclic ether based ratios, materials with higher density and lower thermal insulation are obtained. Gelation does not take place when an excess of cyclic ether is used.

An organic aerogel according to the present invention is obtained in a presence of a solvent. Suitable solvent for use in the present invention is a polar solvent, preferably polar aprotic solvent.

Examples of suitable solvents for use in the present invention are acetone, chloroform, dimethyl sulfoxide, dimethylacetamide, dimethyl formamide, 1-methyl-2-pyrrolidinone, acetonitrile, acetophenone, polypropylene carbonate, water and mixtures thereof.

In one embodiment, the solvent used for the reaction is a mixture of acetonitrile and water.

The amount of solvent used for the present invention allows the reacting components to be stirred in the form of a homogenous mixture. Preferably the solvent is added from 60-95% by weight of the reaction mixture.

In one highly preferred embodiment, an organic aerogel is obtained by reacting an amine compound having at least two amine functionalities and a cyclic ether compound in the presence of a solvent and a catalyst.

Suitable catalyst for use in the present invention is selected from the group consisting of alkyl amines, tertiary amines, hydroxyl containing compounds, imidazole compounds, aza compounds

Suitable catalyst may be selected from the group consisting of triethylamine, benzyldimethylamine (DMBA), 1,4-diazabicyclo[2.2.2]octane (DABCO), 2-ethyl-4-methylimidazole, 2-phenylimidazole, 2-methylimidazole, 1-methylimidazole, 4,4′-methylene-bis(2-ethyl-5-methylimidazole), 3,4,6,7,8,9-hexahydro-2H-pyrimido[1,2-a]pyrimidine, 1,8-diazabicyclo[5.4.0]undec-7-ene (DBU), 1,5,7-triazabicyclo[4.4.0]dec-5-ene (TBD), 1,5-diazabicyclo[4.3.0]non-5-ene, quinuclidine and mixtures thereof.

Preferably said catalyst is selected from the group consisting of 2,4,6-tris(dimethylaminomethyl)phenol, 2-ethyl-4-methylimidazole, triethanolamine, dimethylbenzylamine, 1,8-diazabicyclo[5.4.0]undec-7-ene, 1,4-diazabicyclo[2.2.2]octane and mixtures thereof.

Above-mentioned preferred catalysts are preferred because they provide faster gelation, and require lower temperature for it.

Suitable commercially available catalysts for use in the present invention include, 2,4,6-tris(dimethylaminomethyl)phenol, 2-ethyl-4-methylimidazole, triethanolamine from Aldrich, dimethylbenzylamine (DMBA) and 1,8-diazabycyclo[5.4.0]undec-7-ene (DBU) from Merck; 1,4-diazabicyclo[2.2.2]octane (DABCO) from Acros; and mixtures thereof.

The catalyst is added from 0.5 to 20 wt % of the reaction mixture, without including solvent, preferably from 3 to 15% and more preferably from 5 to 10 wt %.

Addition of the catalyst less than 0.5% results in longer reaction time for formation of organic aerogels according to the present invention, while more than 20% may not affect the reaction progress.

In another embodiment, the organic aerogel of the present invention is further functionalized with a silylation agent. This functionalization confers hydrophobic properties to the organic aerogel.

Suitable silylation agent can be selected from a group consisting of N,O-bis(trimethylsilyl)acetamide, N,O-bis(trimethylsilyl)carbamate, N, N-bis(trimethylsilyl)formamide, bis(trimethylsilyl) sulfate, N,O-bis(trimethylsilyl)trifluoroacetamide, N,N-bis(trimethylsilyl)urea, tert-butyldimethylchlorosilane, N-(trimethylsilyl)acetamide, methylchlorosilanes with the formula Me₄₋ₖSiClₖ, wherein k is from 1 to 3 or hexamethyldisilazane.

Suitable commercially available silylation agents for use in the present invention include, N,O-bis(trimethylsilyl)acetamide, hexamethyldisilazane, trimethylchiorosilane from Aldrich.

The silylation agent is added to the reaction mixture from 5 to 40% by weight of the total solvent used for the solvent exchange, preferably from 7 to 30%, more preferably from 7 to 25% and even more preferably from 10 to 20%.

Addition of the silylation agent in the amount of less than 5% does not confer hydrophobic properties to the organic aerogels according to the present invention, while more than 40% may lead to a deterioration in hydrophobic and/or organic aerogels properties.

An organic aerogel according to the present invention may further comprise at least one reinforcement, wherein said reinforcement is selected from the group consisting of fibres, particles, non-woven and woven fibre fabrics, 3D structures and mixtures thereof.

Non-limiting examples of suitable fibres are cellulose, aramid, carbon, glass and lignocellulosic fibres.

Non-limiting examples of suitable particles are carbon black, microcrystalline cellulose, silica, cork, lignin, and aerogel particles.

Non-limiting examples of suitable fibre fabrics are non-woven and woven glass, aramid, carbon and lignocellulosic fibre fabrics.

Non-limiting examples of suitable 3D structures are aramid fibre-phenolic, glass fibre-phenolic, polycarbonate and polypropylene honeycomb cores.

In a preferred embodiment at least one reinforcement is selected from the group consisting of cellulose fibres, aramid fibres, carbon fibres, glass fibres, lignocellulosic fibres, carbon black, microcrystalline cellulose, silica particles, cork particles, lignin particles, aerogel particles, non-woven and woven glass fibre fabrics, aramid fibre fabrics, carbon fibre fabrics, jute fibre fabrics, flax fibre fabrics, aramid fibre-phenolic honeycomb, glass fibre-phenolic honeycomb, polycarbonate core, polypropylene core, and mixtures thereof, more preferably at least one reinforcement is selected from the group consisting of cellulose fibres, aramid fibres, carbon fibres, glass fibres, carbon black, microcrystalline cellulose, non-woven glass fibre fabrics, woven aramid fibre fabrics, woven jute fibre fabrics, woven flax fibre fabrics, aramid fibre-phenolic honeycomb, glass fibre-phenolic honeycomb and mixtures thereof.

Examples of commercially available reinforcements for use in the present invention are but not limited to Acros Organics microcrystalline cellulose, Evonic Printex II carbon black, α-cellulose Sigma Aldrich powder, Procotex aramid fibre, Procotex CF-MLD100-13010 carbon fibres, E-glass Vetrotex textiles fibres EC9 134 z28 T6M ECG 37 I/O 0.7z, Unfilo® U809 Advantex® glass fiber, Composites Evolution Biotex jute plain weave, Composites Evolution Biotex flax 2/2 twill, Easycomposites aramid cloth fabric satin weave, Euro-composites ECG glass fibre-phenolic honeycomb, Euro-composites ECAI aramid fibre-phenolic honeycomb, Cel Components Alveolar PP8-80T30 3D structure, Cel Components Alveolar 3.5-90 3D structure.

Depending on the reinforcement incorporated into the organic aerogel according to the present invention, the reinforcement percentage in the final material may vary from 0.01% up to 30% based on the total weight of the initial solvent.

In one embodiment, a particle reinforcement such as carbon black is used and the amount added to the material is less than 0.1% based on the total weight of the initial solvent.

In another embodiment, a fibre reinforcement such as glass fibre fabrics are included in the organic aerogel according to the present invention, and the amount added to the material is up to 30% based on the total weight of the initial solvent.

In another embodiment, a 3D structure such as an aramid fibre/phenolic honeycomb is incorporated into organic aerogel according to the present invention as a reinforcement. The amount is around 4% based on the total weight of the initial solvent.

Aerogel compositions of the present disclosure present a wide range of mechanical properties, with compressive modulus ranging from 0.14 MPa for the lightest material up to 74 MPa for the highest density aerogel. Reinforcing forms such as honeycombs can be successfully used, affording compressive modulus up to 80 MPa. Compressive strength is measured according to the standard ASTM D1621.

An organic aerogel according to the present invention has a solid content from 5 to 40%, based on initial solid content of the solution, preferably from 5 to 30% and more preferably from 7 to 25%.

Solid content in the range from 7 to 25% is preferred, because it provides a good compromise between thermal insulating properties and mechanical properties. High solid content provides high mechanical properties; however, high solid content provides poor thermal insulating properties. On the other hand, low solid content provides lower thermal conductivities, but mechanical properties are not ideal.

An organic aerogel according to the present invention has a thermal conductivity less than 65 mW/m·K, preferably less than 50 mW/m·K, more preferably less than 45 mW/m·K, wherein the thermal conductivity is measured according to the test methods described below:

### Diffusivity Sensor Method

In this method, the thermal conductivity is measured by using a diffusivity sensor. In this method, the heat source and the measuring sensor are on the same side of the device. The sensors measure the heat that diffuses from the sensor throughout the materials. This method is appropriate for lab scale tests.

### Steady-State Condition System Method

In this method the thermal conductivity is measured by using a steady-state condition system. In this method, the sample is sandwiched between a heat source and a heat sink. The temperature is risen on one side, the heat flows through the material and once the temperature on the other side is constant, both heat flux and difference of temperatures are known, and thermal conductivity can be measured.

The organic aerogels according to the present invention have a density in the range from 0.125-0.435 g/cm³.

Densities were calculated from the sample weight and dimensions.

The organic aerogels according to the present invention have a linear shrinkage in the range of 6-32%.

Linear shrinkage was calculated by comparing diameter of the mold used for gelation with the diameter of the dry sample.

The organic aerogels according to the invention have a pore size in the range 10-200 nm.

The organic aerogels according to the invention have a surface area in the range 20-400 m²/g.

Pore size and surface area are determined from the N₂ sorption analysis at −196° C., using Brunauer-Emmett-Teller (BET) method.

For the preparation of organic aerogels according to the present invention, several aspects have to be taken into consideration. The stoichiometric ratio of functionalities, the initial solid content, the amount and type of catalyst (if present), type of solvent, gelation time and temperature are important factors that affect to the final properties of the material.

In one embodiment, an organic aerogel according to the present invention is prepared according to a method comprising the steps of:

1) dissolving a cyclic ether compound into a solvent and adding an amine compound and mixing;

2) adding a catalyst, if needed, and mixing;

3) transferring the mixture of step 2) to a sealed mold;

4) heating or maintaining the solution in order to form a gel;

5) washing said gel with a solvent;

6) optionally, adding a silylation agent to the wet gel from step 5) and after reaction completion washing the gel with acetone;

7) drying said gel by
a) supercritical drying
or
b) ambient drying
   wherein, optionally, the CO₂ from the supercritical drying is recycled.

The reaction mixture is prepared in a closed container.

Gelation step (4) is carried out in the oven for the pre-set time and temperature. Preferably, temperature is applied on step (4), from room temperature to 180° C., preferably from 20° C. to 150° C., more preferably from 30° C. to 80° C.

Temperatures from room temperature to 180° C. are preferred because temperatures higher than 180° C. require the use of solvents with extremely high boiling points.

Gelation time is preferably from 1 to 10 days, preferably from 1 to 7 days, and more preferably from 1 to 2 days.

Washing time is preferably from 18 hours to 72 hours, more preferably from 24 hours to 48 hours.

The solvent of wet gels at step (5) is changed one or more times after the gelation. The washing steps are done gradually, and if required, to the preferred solvent for the drying process.

In one embodiment, the washing steps are done gradually as initial solvent/acetone 3:1 (24 h)+initial solvent/acetone 1:1 (24 h)+initial solvent/acetone 1:3 (24 h)+acetone (24 h).

However, based on the starting reaction conditions other solvent combination can also be used. Once the solvent has been completely replaced by acetone, gel is dried in supercritical (CO₂) or ambient conditions obtaining the final aerogel material.

The drying process at supercritical conditions is performed by exchanging the solvent in the gel with CO₂ or other suitable solvents in their supercritical state. Due to this, capillary forces exerted by the solvent during evaporation in the nanometric pores are minimized and shrinkage of the gel body can be reduced.

In one embodiment, the method for preparing the organic aerogel involves the recycling of the CO₂ from the supercritical drying step.

Alternatively, wet gels can be dried at ambient conditions, in which the solvent is evaporated at room temperature. However, as the liquid evaporates from the pores, it can create a meniscus that recedes back into the gel due to the difference between interfacial energies. This may create a capillary stress on the gel, which responds by shrinking. If these forces are higher enough, they can even lead to the collapse or cracking of the whole structure. However, there are different possibilities to minimize this phenomenon. One practical solution involves the use of solvents with low surface tension to minimize the interfacial energy between the liquid and the pore. Unfortunately, not all the solvents lead to gelation, which means that some cases would require the exchange of solvent between an initial one required for the gel formation and a second one most appropriate for the drying process. Hexane is usually used as a convenient solvent for ambient drying, as its surface tension is one of the lowest among the conventional solvents.

One embodiment encompasses a thermal insulating material or an acoustic material comprising an organic aerogel according to the present invention.

The present invention also encompasses a use of an organic aerogel according to the present invention as a thermal insulating material or acoustic material.

Organic aerogels according to the present invention can be used for thermal insulation in different applications such as aircrafts, space crafts, pipelines, tankers and maritime ships replacing currently used foam panels and other foam products, in car battery housings and under hood liners, lamps, in cold packaging technology including tanks and boxes, jackets and footwear and tents.

Organic aerogels according to the present invention can also be used in construction materials due to their lightweight, strength, ability to be formed into desired shapes and superior thermal insulation properties.

Organic aerogels according to the present invention can be also used for storage of cryogens.

Organic aerogels according to the present invention can be also used as an adsorption agent for oil spill clean-up, due to their high oil absorption rate.

Organic aerogels according to the present invention can be also used in safety and protective equipment as a shock-absorbing medium.

### EXAMPLES

Test methods used in the following examples for determination of the properties of the organic aerogels are those described in the description.

For all the examples following test methods were used:

Thermal conductivity measured with the C-Therm TCi.

Mechanical properties (compression modulus) determined in accordance with ASTM D1621.

Density was determined as the mass of aerogel divided by the geometrical volume of aerogel.

$$Density = \frac{aerogel mass}{aerogel volume}$$

Linear shrinkage was determined as the difference between the gel and aerogel diameters divided by the gel diameter.

$$Linear shrinkage ( \% ) = ( \frac{Gel diameter - Aerogel diameter}{Gel diameter} ) \cdot 100$$

### Example 1: Amine/Epoxy Aerogels Prepared in 1:1 Ratio from a Difunctional Amine and a Trifunctional Epoxide in Chloroform (CHCl₃) as Solvent

Amine/Epoxy aerogels were prepared from monomers 1,3-diaminopropane (DAP) (from Merck) and N,N-diglycidyl-4-glycidyloxyaniline (Araldite MY0510) (from Huntsman).

1.50 g (5.41 mmol) of Araldite MY0510 was charged to a container with 10.7 mL (16 g) of CHCl₃. The resulting slurry was stirred at 300 rpm for 5 minutes at 20° C. DAP (0.31 mL, 3.71 mmol) was then added with continuous stirring at 300 rpm in an equivalent ratio 1:1 with respect to the epoxy. Final solid content of the solution was approximately 10 wt %. The reaction mixture was then poured into a teflon sealed mold and heated up for 48 hours at 45° C. inside an oven. A white gel was obtained.

The resulting gel was then stepwise washed in a mixture of acetone 1:3 CHCl₃, acetone 1:1 CHCl₃, acetone 3:1 CHCl₃ and acetone, during 24 h for each step, and using three times the volume of the gel in solvent for each step.

The material was dried by supercritical drying with supercritical carbon dioxide.

Table 1 illustrates the results regarding density, linear shrinkage, thermal conductivity and compressive modulus.

TABLE 1

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.154 | 7 | 40 | 1.04 |

### Example 2: Amine/Epoxy Aerogels Prepared in 1:1 Ratio from a Trifunctional Amine and a Trifunctional Epoxide in Chloroform (CHCl₃) as Solvent

Amine/Epoxy aerogels were prepared from monomers N1-(3-trimethoxysilylpropyl)diethylenetriamine (from Aldrich) and N,N-diglycidyl-4-glycidyloxyaniline (Araldite MY0510) (from Huntsman).

1.07 g (3.86 mmol) of Araldite MY0510 was charged to a container with 10.7 mL (16 g) of CHCl₃. The resulting slurry was stirred at 300 rpm for 5 minutes at 20° C. N1-(3-trimethoxysilylpropyl)diethylenetriamine (0.70 mL, 2.64 mmol) was then added with continuous stirring at 300 rpm in an equivalent ratio 1:1 with respect to the epoxy. Subsequently, 0.20 mL (1.31 mmol) of dimethylbenzylamine (DMBA) catalyst was added while continuing stirring at 300 rpm. Final solid content of the solution was approximately 10 wt %. The reaction mixture was then poured into a teflon sealed mold and heated up for 7 days at 45° C. inside an oven. A yellow gel was obtained.

The resulting gel was then stepwise washed in a mixture of acetone 1:3 CHCl₃, acetone 1:1 CHCl₃, acetone 3:1 CHCl₃ and acetone, during 24 h for each step, and using three times the volume of the gel in solvent for each step.

The material was dried by supercritical drying with supercritical carbon dioxide.

Table 2 illustrates the results regarding density, linear shrinkage, thermal conductivity and compressive modulus.

TABLE 2

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.383 | 32 | 60 | 63 |

### Example 3: Amine/Epoxy Aerogels Prepared in 1:1 Ratio from a Tetra Functional Amine and a Trifunctional Epoxide in a Mixture of Acetonitrile/Water as Solvent

Amine/Epoxy aerogels were prepared from monomers triethylenetetramine (TETA) (from Merck) and N,N-Diglycidyl-4-glycidyloxyaniline (Araldite MY0510) (from Huntsman).

1.43 g (5.16 mmol) of Araldite MY0510 was charged to a container with 10.7 mL (16 g) of a mixture of acetonitrile/water (1.25/1). The resulting slurry was stirred at 300 rpm for 5 minutes at 20° C. TETA (0.35 mL, 2.37 mmol) was then added with continuous stirring at 300 rpm in an equivalent ratio 1:1 with respect to the epoxy. Final solid content of the solution was approximately 10 wt %. The reaction mixture was then poured into a sealed mold and heated up for 180 min at 80° C. inside an oven. A white gel was obtained.

The resulting gel was then stepwise washed in a mixture of acetone 1:3 acetonitrile/water, acetone 1:1 acetonitrile/water, acetone 3:1 acetonitrile/water and acetone, during 24 h for each step, and using three times the volume of the gel in solvent for each step.

The material was dried by supercritical drying with supercritical carbon dioxide.

Table 3 illustrates the results regarding density, linear shrinkage, thermal conductivity and compressive modulus.

TABLE 3

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.125 | 10 | 36 | 0.14 |

### Example 4: Amine/Epoxy Aerogels Prepared in 1:1 Ratio from a Pentafunctional Amine and a Trifunctional Epoxide in Chloroform (CHCl₃) as Solvent

Amine/Epoxy aerogels were prepared from monomers Tetraethylenepentamine (TEPA) (from Merck) and N,N-diglycidyl-4-glycidyloxyaniline (Araldite MY0510) (from Huntsman).

1.40 g (5.05 mmol) of Araldite MY0510 was charged to a container with 10.7 mL (16 g) of CHCl₃. The resulting slurry was stirred at 300 rpm for 5 minutes at 20° C. TEPA (0.37 mL, 1.95 mmol) was then added with continuous stirring at 300 rpm in an equivalent ratio 1:1 with respect to the epoxy. Subsequently, 0.20 mL (1.31 mmol) of dimethylbenzylamine (DMBA) catalyst were added while continuing stirring at 300 rpm. Final solid content of the solution was approximately 10 wt %. The reaction mixture was then poured into a teflon sealed mold and heated up for 96 hours at 45° C. inside an oven. A white gel was obtained.

The resulting gel was then stepwise washed in a mixture of acetone 1:3 CHCl₃, acetone 1:1 CHCl₃, acetone 3:1 CHCl₃ and acetone, during 24 h for each step, and using three times the volume of the gel in solvent for each step.

The material was dried by supercritical drying with supercritical carbon dioxide.

Table 4 illustrates the results regarding density, linear shrinkage, thermal conductivity and compressive modulus.

TABLE 4

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.226 | 18.5 | 38 | 6.0 |

### Example 5: Amine/Epoxy Aerogels Prepared in a 1:1 Ratio from a Difunctional Amine and a Tetra Functional Epoxide

Amine/Epoxy aerogels were prepared from monomers 1,3-diaminopropane (DAP) (from Merck) and 1,1,2,2-tetra(p-hydroxyphenyl)-ethane tetraglycidyl ether (Araldite XB-4399-3) (from Huntsman).

1.64 g (2.63 mmol) of Araldite XB-4399-3 was charged to a container with 10.7 mL (16 g) of CHCl₃. The resulting slurry was stirred at 300 rpm for 5 minutes at 20° C. DAP (0.15 mL, 1.78 mmol) was then added with continuous stirring at 300 rpm in an equivalent ratio 1:1 with respect to the epoxy. Final solid content of the solution was approximately 10 wt %. The reaction mixture was then poured into a teflon sealed mold and maintained at room temperature for 5 days. A yellow gel was obtained.

The resulting gel was then stepwise washed in a mixture of acetone 1:3 CHCl₃, acetone 1:1 CHCl₃, acetone 3:1 CHCl₃ and acetone, during 24 h for each step, and using three times the volume of the gel in solvent for each step.

The material was dried by supercritical drying with supercritical carbon dioxide.

Table 5 illustrates the results regarding density, linear shrinkage, thermal conductivity and compressive modulus.

TABLE 5

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.308 | 25 | 43 | 24.4 |

### Example 6: Amine/Epoxy Aerogels Prepared in a 1:1 Ratio from a Difunctional Amine and a Pentafunctional Epoxide

Amine/Epoxy aerogels were prepared from monomers 1,3-diaminopropane (DAP) (from Merck) and poly[(o-cresyl glycidyl ether)-co-formaldehyde (from Aldrich).

3.28 g (3.03 mmol) of poly[(o-cresyl glycidyl ether)-co-formaldehyde was charged to a container with 21.5 mL (32 g) of CHCl₃. The resulting slurry was stirred at 300 rpm for 5 minutes at 20° C. DAP (0.30 mL, 3.66 mmol) was then added with continuous stirring at 300 rpm in an equivalent ratio 1:1 with respect to the epoxy. Subsequently, 0.40 mL (2.62 mmol) of dimethylbenzylamine (DMBA) catalyst was added while continuing stirring at 300 rpm. Final solid content of the solution was approximately 10 wt %. The reaction mixture was then poured into a teflon sealed mold and maintained at 45° C. for 2 days. A white gel was obtained.

The resulting gel was then stepwise washed in a mixture of acetone 1:3 CHCl₃, acetone 1:1 CHCl₃, acetone 3:1 CHCl₃ and acetone, during 24 h for each step, and using three times the volume of the gel in solvent for each step.

The material was dried by supercritical drying with supercritical carbon dioxide.

Table 6 illustrates the results regarding density, linear shrinkage, thermal conductivity and compressive modulus.

TABLE 6

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.435 | 31 | 55 | 74 |

### Example 7: Amine/Epoxy Aerogels Prepared in a 1:1 Ratio from a Cycloaliphatic Amine

Amine/Epoxy aerogels were prepared from monomers Isophorone diamine (IPD) (from Merck) and N,N-diglycidyl-4-glycidyloxyaniline (Araldite MY0510) (from Huntsman). Dimethylbenzylamine (DMBA) was used as catalyst.

1.25 g (4.51 mmol) of Araldite MY0510 was charged to a container with 10.7 mL (16 g) of CHCl₃. The resulting slurry was stirred at 300 rpm for 5 minutes at 20° C. IPD (0.57 mL, 3.12 mmol) was then added with continuous stirring in an equivalent ratio 1:1 with respect to the epoxy. Subsequently, 0.20 mL (1.31 mmol) of dimethylbenzylamine (DMBA) catalyst was added while continuing stirring at 300 rpm. Final solid content of the solution was approximately 10 wt %. The reaction mixture was then poured into a teflon sealed mold and maintained at 45° C. for 2 days. A white gel was obtained.

The resulting gel was then stepwise washed in a mixture of acetone 1:3 CHCl₃, acetone 1:1 CHCl₃, acetone 3:1 CHCl₃ and acetone, during 24 h for each step, and using three times the volume of the gel in solvent for each step.

The material was dried by supercritical drying with supercritical carbon dioxide.

Table 7 illustrates the results regarding density, linear shrinkage, thermal conductivity and compressive modulus.

TABLE 7

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.384 | 15 | 43 | 15.0 |

### Example 8: Amine/Epoxy Aerogels Prepared in a 1:1 Ratio from an Aromatic Amine

Amine/Epoxy aerogels were prepared from monomers para-phenylenediamine (PPD) (from Merck) and N,N-Diglycidyl-4-glycidyloxyaniline (Araldite MY0510) (from Huntsman). Dimethylbenzylamine (DMBA) was used as catalyst.

1.40 g (5.05 mmol) of Araldite MY0510 was charged to a container with 14.5 mL (16 g) of DMSO. The resulting slurry was stirred at 300 rpm for 5 minutes at 20° C. PPD (0.375 g, 3.47 mmol) was then added with continuous stirring in an equivalent ratio 1:1 with respect to the epoxy. Subsequently, 0.20 mL (1.31 mmol) of dimethylbenzylamine (DMBA) catalyst was added while continuing stirring at 300 rpm. Final solid content of the solution was approximately 10 wt %. The reaction mixture was then poured into a teflon sealed mold and maintained at 130° C. for 12 hours. A dark gel was obtained.

The resulting gel was then stepwise washed in a mixture of acetone 1:3 DMSO, acetone 1:1 DMSO, acetone 3:1 DMSO and acetone, during 24 h for each step, and using three times the volume of the gel in solvent for each step.

The material was dried by supercritical drying with supercritical carbon dioxide.

Table 8 illustrates the results regarding density, linear shrinkage, thermal conductivity and compressive modulus.

TABLE 8

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.296 | 29 | 40 | —^{#} |

^{#}Heterogeneous aerogel, “cracked-like structure”.

### Example 9: Amine/Epoxy Aerogels Prepared in 2:1 Ratio from a Difunctional Amine and a Trifunctional Epoxide in Chloroform (CHCl₃) as Solvent

Amine/Epoxy aerogels were prepared from monomers 1,3-diaminopropane (DAP) (from Merck) and N,N-diglycidyl-4-glycidyloxyaniline (Araldite MY0510) (from Huntsman).

0.81 g (2.92 mmol) of Araldite MY0510 was charged to a container with 6.7 mL (10 g) of CHCl₃. The resulting slurry was stirred at 300 rpm for 5 minutes at 20° C. DAP (0.33 mL, 3.98 mmol) was then added with continuous stirring at 300 rpm in an equivalent ratio 2:1 with respect to the epoxy. Final solid content of the solution was approximately 10 wt %. The reaction mixture was then poured into a teflon sealed mold and maintained at room temperature for 7 days. A white gel was obtained.

The resulting gel was then stepwise washed in a mixture of acetone 1:3 CHCl₃, acetone 1:1 CHCl₃, acetone 3:1 CHCl₃ and acetone, during 24 h for each step, and using three times the volume of the gel in solvent for each step.

The material was dried by supercritical drying with supercritical carbon dioxide.

Table 9 illustrates the results regarding density, linear shrinkage, thermal conductivity and compressive modulus.

TABLE 9

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.251 | 6 | 49 | 4.3 |

### Example 10: Amine/Epoxy Aerogels Prepared in a 1:1 Ratio Varying the Initial Solid Content

Amine/Epoxy aerogels were prepared from monomers 1,3-diaminopropane (DAP) (from Merck) and 1,1,2,2-tetra(p-hydroxyphenyl)-ethane tetraglycidyl ether (Araldite XB-4399-3) (from Huntsman).

Solutions were prepared varying the total solid amount. Thus, as an illustrative example, solutions having 7.5 wt % total solid content were prepared by dissolving 2.40 g (3.85 mmol) of Araldite XB-4399-3 with 21.5 mL (32 g) CHCl₃ in a container. The resulting slurry was stirred at 300 rpm for 5 minutes at 20° C. DAP (0.22 mL, 2.62 mmol) was then added with continuous stirring in an equivalent ratio 1:1 with respect to the epoxy. Subsequently, 0.29 mL (1.92 mmol) of dimethylbenzylamine (DMBA) catalyst was added while continuing stirring at 300 rpm. The reaction mixture was then poured into a teflon sealed mold and maintained at 45° C. for 2-3 days. A yellow gel was obtained.

The resulting gel was then washed in a mixture of acetone 1:3 CHCl₃, acetone 1:1 CHCl₃, acetone 3:1 CHCl₃ and acetone, during 24 h for each step, and using three times the volume of the gel in solvent for each step.

The material was dried by supercritical drying with supercritical carbon dioxide.

Table 10 illustrates the results regarding density, linear shrinkage, thermal conductivity and compressive modulus.

TABLE 10

| | | | | | Compres- |
|---|---|---|---|---|---|
| | Solid | | Linear | Thermal | sive |
| | Content | Density | Shrinkage | Conductivity | Modulus |
| Aerogel | (wt %) | (g/cm³) | (%) | (mW/m · K) | (MPa) |
| Amine/epoxy | 5 | 0.180 | 13 | 45 | 0.2 |
| Amine/epoxy | 7.5 | 0.210 | 11 | 48 | 1.1 |
| Amine/epoxy | 10 | 0.214 | 13 | 43 | 11.6 |

### Example 11: Amine/Epoxy Aerogels Prepared in a 1:1 Ratio in the Presence of Different Catalysts

Amine/Epoxy aerogels were prepared from monomers 1,3-diaminopropane (DAP) (from Merck) and 1,1,2,2-tetra(p-hydroxyphenyl)-ethane tetraglycidyl ether (Araldite XB-4399-3) (from Huntsman). The catalysts tested were a) 2,4,6-tris(dimethylaminomethyl)phenol, b) 2-ethyl-4-methyl-imidazol (IM), c) triethanolamine, d) dimethylbenzylamine (DMBA), e) 8-diazabicyclo[5.4.0]undec-7-ene (DBU), f) 1,4-diazabicyclo[2.2.2]octane (DABCO).

Solutions were prepared varying the type of catalyst. 1.64 g (2.63 mmol) of Araldite XB-4399-3 was charged to a container with 10.7 mL (16 g) of CHCl₃. The resulting slurry was stirred at 300 rpm for 5 minutes at 20° C. DAP (0.15 mL, 1.78 mmol) was then added with continuous stirring in an equivalent ratio 1:1 with respect to the epoxy. Subsequently, the catalyst of choice (10 wt % of the total solid amount) was added while continuing stirring at 300 rpm. Final solid contents of the solutions were approximately 10 wt %. The reaction mixtures were then poured into a teflon sealed mold and maintained at room temperature for required time. Yellow gels were usually obtained.

The resulting gels were then stepwise washed in mixtures of acetone 1:3 CHCl₃, acetone 1:1 CHCl₃, acetone 3:1 CHCl₃ and acetone, during 24 h for each step, and using three times the volume of the gel in solvent for each step

The materials were dried by supercritical drying with supercritical carbon dioxide.

Table 11 illustrates the results regarding density, linear shrinkage, thermal conductivity and compressive modulus.

TABLE 11

| | | | | Linear | Thermal |
|---|---|---|---|---|---|
| | | Gelation | | Shrink- | Conduc- |
| | | time | Density | age | tivity |
| Aerogel | Catalyst | (days) | (g/cm³) | (%) | (mW/m · K) |
| Amine/epoxy | DMBA | 2-3 | 0.184 | 11.5 | 40 |
| Amine/epoxy | Trietha- | 2-3 | 0.370 | 27 | 43 |
| | nolamine | | | | |
| Amine/epoxy | DBU | 6 | 0.264 | 15 | 41 |
| Amine/epoxy | DMP-30 | 2-3 | 0.396 | 23 | 47 |
| Amine/epoxy | IM | 2-3 | 0.329 | 20 | 43 |
| Amine/epoxy | DABCO | 2 | —^{#} | —^{#} | —^{#} |

^{#}Heterogeneous gel.

### Example 12: Amine/Epoxy Aerogels Prepared in a 1:1 Ratio in the Presence of Different Amounts of Catalyst

Amine/Epoxy aerogels were prepared from monomers 1,3-diaminopropane (DAP) (from Merck) and 1,1,2,2-tetra(p-hydroxyphenyl)-ethane tetraglycidyl ether (Araldite XB-4399-3) (from Huntsman). Dimethylbenzylamine (DMBA) was used as catalyst.

1.64 g (2.63 mmol) of Araldite XB-4399-3 was charged to a container with 10.7 mL (16 g) of CHCl₃. The resulting slurry was stirred at 300 rpm for 5 minutes at 20° C. DAP (0.15 mL, 1.78 mmol) was then added with continuous stirring in an equivalent ratio 1:1 with respect to the epoxy. Subsequently, dimethylbenzylamine (DMBA) catalyst was added while continuing stirring at 300 rpm. Experiments with different catalyst amounts were performed (1, 5, 10 and 20 wt % of the total solid amount). Final solid contents of the solutions were approximately 10 wt %. The reaction mixtures were then poured into a teflon sealed mold and maintained at 45° C. for 1 day. Yellow gels were obtained.

The resulting gels were then stepwise washed in mixtures of acetone 1:3 CHCl₃, acetone 1:1 CHCl₃, acetone 3:1 CHCl₃ and acetone, during 24 h for each step, and using three times the volume of the gel in solvent for each step.

The materials were dried by supercritical drying with supercritical carbon dioxide.

Table 12 illustrates the results regarding density, linear shrinkage, thermal conductivity and compressive modulus with various quantities of catalyst.

TABLE 12

| | | Linear | Thermal | Compressive |
|---|---|---|---|---|
| Catalyst | Density | Shrinkage | Conductivity | Modulus |
| amounts | (g/cm³) | (%) | (mW/m · K) | (MPa) |
| 1 | 0.290 | 18 | 45 | 23.8 |
| 5 | 0.230 | 12 | 42 | 5.1 |
| 10 | 0.214 | 13 | 43 | 11.6 |
| 20 | 0.251 | 9 | 55 | 2.6 |

### Example 13: Honeycomb Reinforced Amine/Epoxy Aerogels Prepared in 1:1 Ratio

Amine/Epoxy aerogels, prepared from monomers triethylenetetramine (TETA) (from Merck) and N,N-diglycidyl-4-glycidyloxyaniline (Araldite MY0510) (from Huntsman) were reinforced with Aramid fiber-phenolic honeycomb.

1.43 g (5.16 mmol) of Araldite MY0510 was charged to a container with 18 mL (16 g) of a mixture of acetonitrile/water (1.25/1). The resulting slurry was stirred at 300 rpm for 5 minutes at 20° C. TETA (0.35 mL, 2.37 mmol) was then added with continuous stirring at 300 rpm in an equivalent ratio 1:1 with respect to the epoxy. Final solid content of the solution was approximately 10 wt %. The reaction mixture was then poured into a sealed mold containing a honeycomb core, and heated up for 180 min at 80° C. inside an oven. A white gel with the honeycomb embedded was obtained.

The resulting gel was then stepwise washed in a mixture of acetone 1:3 acetonitrile/water, acetone 1:1 acetonitrile/water, acetone 3:1 acetonitrile/water and acetone, during 24 h for each step, and using three times the volume of the gel in solvent for each step.

The material was dried by supercritical drying with supercritical carbon dioxide.

Table 13 illustrates the results regarding density, linear shrinkage, thermal conductivity and compressive modulus.

TABLE 13

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/Epoxy | 0.125 | 10 | 36 | 0.16 |
| Reinforced | 0.134 | 0 | 36 | 73.8 |
| Amine/Epoxy | | | | |

### Example 14: Amine/Epoxy Xerogels Prepared in 2:1 Ratio by Ambient Drying

Amine/Epoxy xerogels were prepared from monomers 1,3-diaminopropane (DAP) (from Merck) and N,N-Diglycidyl-4-glycidyloxyaniline (Araldite MY0510) (from Huntsman).

0.81 g (2.92 mmol) of Araldite MY0510 was charged to a container with 6.7 mL (10 g) of CHCl₃. The resulting slurry was stirred at 300 rpm for 5 minutes at 20° C. DAP (0.33 mL, 3.98 mmol) was then added with continuous stirring at 300 rpm in an equivalent ratio 2:1 with respect to the epoxy. Final solid content of the solution was approximately 10 wt %. The reaction mixture was then poured into a teflon sealed mold and maintained at room temperature for 7 days. A white gel was obtained.

The resulting gel was then washed several times with fresh CHCl₃, using three times the volume of the gel in solvent for each time.

The material was let dry at ambient conditions (ambient drying).

Table 14 illustrates the results regarding density, linear shrinkage, thermal conductivity and compressive modulus.

TABLE 14

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.345 | 4 | 62 | 11.84 |

### Example 15: Hydrophobic Amine/Epoxy Aerogels Prepared by Surface Silylation on Wet Gel

Amine/Epoxy wet gels were prepared from monomers triethylenetetramine (TETA) (from Merck) and 4,4′-methylene bis(N,N-diglycidylaniline) (Araldite MY0720) (from Huntsman).

1.12 g (2.66 mmol) of Araldite MY720 was added to a container with 12 mL (16 g) of a mixture of CHCl₃/acetonitrile (3/1). The resulting slurry was stirred at 300 rpm for 5 minutes at 25° C. TETA (0.27 mL, 1.79 mmol) was then added with continuous stirring at 300 rpm in an equivalent ratio 1:1 with respect to the epoxy. Subsequently, 0.88 mL (5.90 mmol) of dimethylbenzylamine (DMBA) catalyst were added while continuing stirring at 300 rpm. Final solid content of the solution was approximately 8 wt %. The reaction mixture was then poured into a sealed mold and heated up for 48 hours at 45° C. inside an oven. A white gel was obtained.

The resulting gel was then stepwise washed in a mixture of acetone 1:3 CHCl₃/acetonitrile, acetone 1:1 CHCl₃/acetonitrile, acetone 3:1 CHCl₃/acetonitrile and acetone, during 24 h for each step, and using three times the volume of the gel in solvent for each step.

After exchanging the solvent for acetone, in a further step, 15 vol. % of N,O-bis(trimethylsilyl)acetamide was added to the mixture of acetone and wet gel, and the whole treated at 45° C. for 24 h. After the reaction was complete, the modified gel was again washed with acetone at least twice The material was dried by supercritical drying with supercritical carbon dioxide.

Table 15 illustrates the results regarding density, linear shrinkage, thermal conductivity and compressive modulus.

TABLE 15

| | | Linear | Thermal | Compressive |
|---|---|---|---|---|
| | Density | Shrinkage | Conductivity | Modulus |
| Aerogel | (g/cm³) | (%) | (mW/m · K) | (MPa) |
| Amine/epoxy | 0.117 | 7 | 37 | 1.0 |

### Example 16

The solution was composed of Epiclon HP-7200H (an epoxy polymer based on Dicyclopentadiene), DMSO (solvent), Triethylene tetra-amine (TETA) (a functional aliphatic amine) and DMP-30 (a catalyst). This solution was prepared with an equivalent ratio of 1:1-epoxy:amine. The solid content of the solution was 10 wt %.

For the preparation of a sample of 30 mL, 2.97 g of Epiclon HP7200H was dissolved in 29.08 g of DMSO, subsequently 0.26 g of TETA was added, followed by incorporation of 0.32 g of DMP-30. The resulting solution was placed into an oven at 80° C. for 3 days to obtain a gel. The gel was washed stepwise in a mixture of acetone 1:3 DMSO, acetone 1:1 DMSO, acetone 3:1 DMSO and acetone. The duration of each step was 24 h, and a volume of solvent, three times the volume of the gel, was used for each step. Subsequently the gel was dried via CO2 supercritical drying (SCD). Table 16 illustrates the results regarding density, linear shrinkage, thermal conductivity and compressive modulus.

TABLE 16

| | Linear | Thermal | Compression |
|---|---|---|---|
| Density | shrinkage | conductivity | Modulus |
| (g/cm³) | (%) | (mW/m · K) | (MPa) |
| 0.216 | 28.42 | To be | 33.61 |
| | | measured | |

### Example 17

The solution was composed of Epiclon HP-5000 (a Naphthalene backbone modified polyfunctional type epoxy), MIBK (solvent), Triethylene tetra-amine (TETA) (a functional aliphatic amine) and DMP-30 (a catalyst). This solution was prepared with an equivalent ratio of 1:1-epoxy:amine. The solid content of the solution was 15 wt %.

For the preparation of a sample of 30 mL, 3.34 g of Epiclon HP5000 was dissolved in 20.77 g of MIBK, subsequently 0.32 g of TETA was added, followed by incorporation of 0.37 g of DMP-30. The resulting solution was placed into an oven at 80° C. for 24 h to obtain a gel. The gel was washed stepwise in a mixture of acetone 1:3 MIBK, acetone 1:1 MIBK, acetone 3:1 MIBK and acetone. The duration of each step was 24 h, and a volume of solvent, three times the volume of the gel, was used for each step. Subsequently the gel was dried via CO₂ supercritical drying (SCD). Table 17 illustrates the results regarding density, linear shrinkage, thermal conductivity and compressive modulus.

TABLE 17

| | Linear | Thermal | Compression |
|---|---|---|---|
| Density | shrinkage | conductivity | Modulus |
| (g/cm³) | (%) | (mW/m · K) | (MPa) |
| 0.141 | 12.13 | To be | 1.20 |
| | | measured | |

### Example 18

The solution was composed of Cardolite NC-514 (a di-functional glycidyl ether epoxy resin), MIBK (solvent), diaminodiphenylsulfone (DDS, Dapsone), (a di-functional aromatic amine) and DMP-30 (a catalyst). This solution was prepared with an equivalent ratio of 1:1-epoxy:amine. The solid content of the solution was 10 wt %.

For the preparation of a sample of 30 mL, 2.19 g of Cardolite NC-514 was dissolved in 22.11 g of MIBK, subsequently 0.27 g of DDS was added, followed by incorporation of 0.25 g of DMP-30. The resulting solution was placed into an oven at 80° C. for 48 h to obtain a gel. The gel was washed stepwise in a mixture of acetone 1:3 MIBK, acetone 1:1 MIBK, acetone 3:1 MIBK and acetone. The duration of each step was 24 h, and a volume of solvent, three times the volume of the gel, was used for each step. Subsequently the gel was dried via CO₂ supercritical drying (SCD). Table 18 illustrates the results regarding density, linear shrinkage, thermal conductivity and compressive modulus.

TABLE 18

| | Linear | Thermal | Compression |
|---|---|---|---|
| Density | shrinkage | conductivity | Modulus |
| (g/cm³) | (%) | (mW/m · K) | (MPa) |
| 0.095 | 14.04 | To be | To be |
| | | measured | measured |

### Example 19

The solution was composed of Epiclon HP-9500 (a naphthalene-based novolac epoxy resin), MIBK (solvent), Priamine 1071, (a bio based, low viscous dimer diamine from Croda) and DMP-30 (a catalyst). The solution was prepared with an equivalent ratio of 1:1-epoxy:amine. The solid content of the solution was 10 wt %.

For the preparation of a sample of 30 mL, 1.50 g of Epiclon HP-9500 was dissolved in 21.78 g of MIBK, subsequently 0.92 g of Priamine 1071 was added, followed by incorporation of 0.24 g of DMP-30. The resulting solution was placed into an oven at 80° C. for 48 h to obtain a gel. The gel was washed stepwise in a mixture of acetone 1:3 MIBK, acetone 1:1 MIBK, acetone 3:1 MIBK and acetone. The duration of each washing step was 24 h, and a volume of solvent, three times the volume of the gel, was used for each washing step. Subsequently the gel was dried via CO₂ supercritical drying (SCD). Table 19 illustrates the results regarding density, linear shrinkage, thermal conductivity and compressive modulus.

TABLE 19

| | Linear | Thermal | Compression |
|---|---|---|---|
| Density | shrinkage | conductivity | Modulus |
| (g/cm³) | (%) | (mW/m · K) | (MPa) |
| 0.211 | 24.26 | To be | To be |
| | | measured | measured |

Organic aerogels according to the present invention show densities in the range of 0.1 to 0.4 g/cm³ and compression moduli from 0.1 MPa up to 74 MPa. Thermal conductivity of the organic aerogels can be measured by means of a diffusivity method. Organic aerogels according to the present invention show thermal conductivity coefficients in the range of 36 up to 62 mW/mK.

What is claimed is:

1. An organic aerogel obtained by reacting an amine compound having at least two amine functionalities and a cyclic ether compound in the presence of a solvent.

2. An organic aerogel according to claim 1, wherein said aerogel is obtained by reaction in the presence of a catalyst.

3. An organic aerogel according to claim 1, wherein said aerogel is reacted further with a silylation agent.

4. An organic aerogel according to claim 1, wherein said amine compound has at least one primary amine functionality and total amine functionality from 2 to 10.

5. An organic aerogel according to claim 1, wherein said amine compound is an aliphatic amine compound or cycloaliphatic amine compound or an aromatic amine compound or oligomeric polyamine compound, preferably said amine compound is an aliphatic amine.

6. An organic aerogel according to claim 1, wherein said amine compound has a general structure of 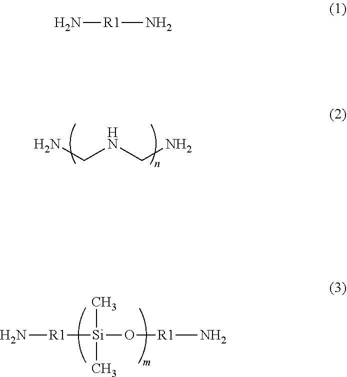
wherein R1 is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination thereof; n is an integer from 1 to 30; and m is an integer from 1 to 30;
or 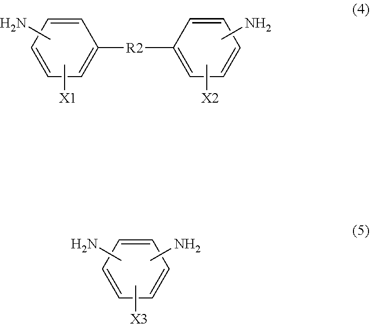
wherein R2 is selected from the group consisting of —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted C3-C30 heterocycloalkyl group and a substituted or unsubstituted C1-C30 heteroalkyl group and a combination thereof; X1, X2 and X3 are same or different substituents and are selected independently from the group consisting of hydrogen, halogen, alkoxy and linear and branched C1-C6 alkyl groups;
or 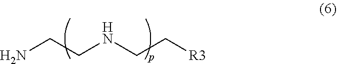
wherein R3 is —Si(OC_{z}H_{2z+1})₃, wherein z is an integer from 1 to 6; and p is an integer from 1 to 30;
or 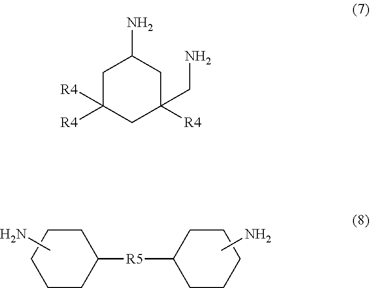
wherein R4 is selected from the group consisting of linear and branched C1-C6 alkyl groups; R5 is selected from the group consisting of —O—, —S—, —S(O)₂—, —S(PO₃)—, substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof.

7. An organic aerogel according to claim 1, wherein said cyclic ether compound is an epoxy compound having a functionality from 2 to 10 and has a general structure of 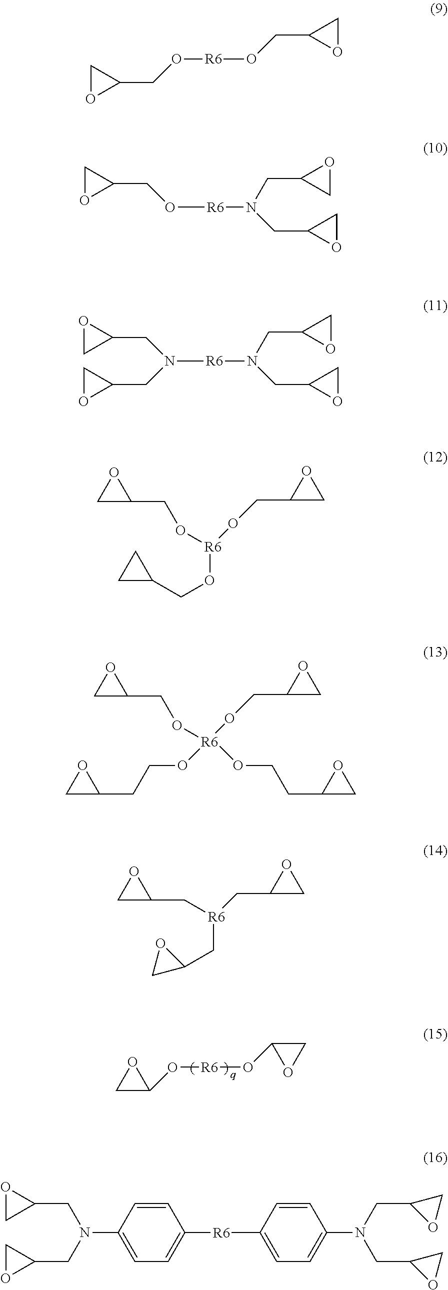
wherein R6 is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination thereof; and q is an integer from 1 to 30;
or 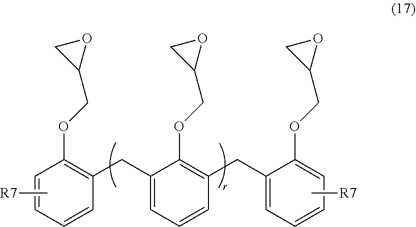
wherein R7 is selected independently from the group consisting of hydrogen, halogen, alkyl and alkenyl; and r is an integer from 1 to 10;
or 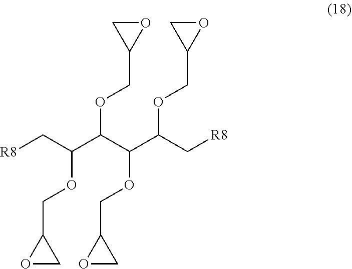
wherein R8 is selected independently from the group consisting of hydrogen, hydroxyl, halogen, alkyl and alkenyl;
or 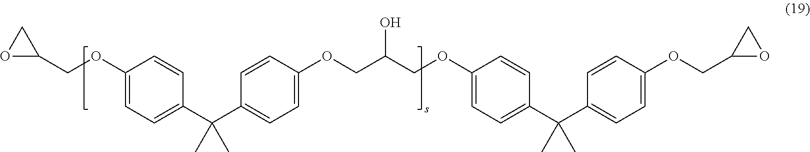
wherein s is an integer from 0 to 16;
or 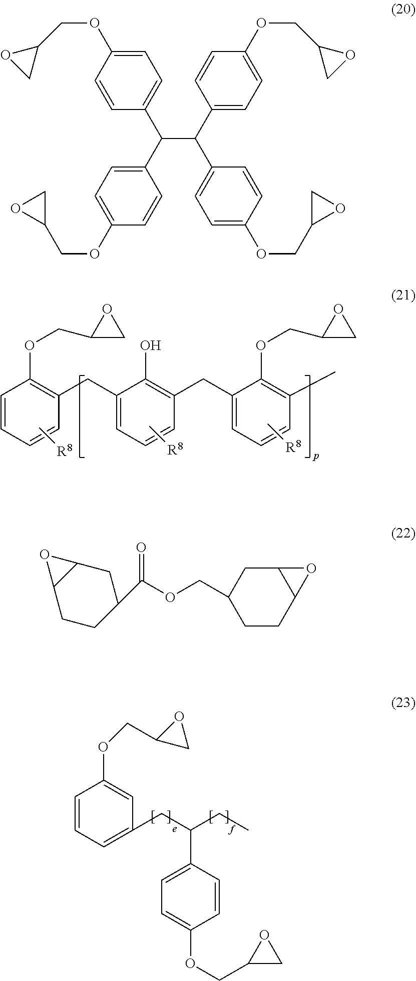
wherein R⁸ represents a substituent or different substituents and is selected independently from a group consisting of hydrogen, halogen and linear or branched C1-C15 alkyl or alkenyl groups, attached to their respective phenyl ring at the 3-, 4- or 5-position and their respective isomers and p is an integer from 1 to 5; wherein e and f are integers from 1 to 10; 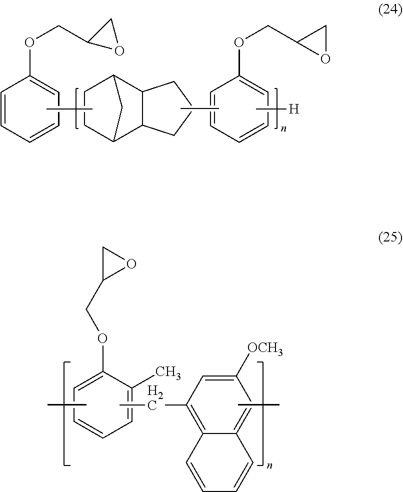
wherein n is an integer from 1 to 5; 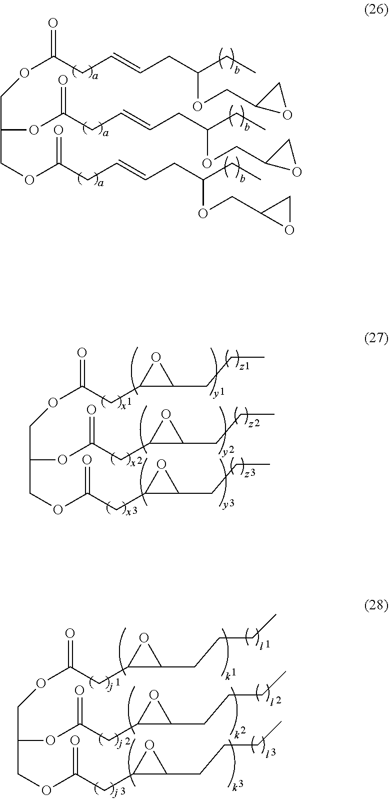
wherein a and b independently are from 1 to 12; wherein x¹, x², x³ are independently from 1 to 26 y¹, y², y³ are independently from 0 to 6, provided y¹+y²+y³ is at least 2 and z¹, z², z³ are independently from 0 to 25; wherein j¹, j², j³ are independently from 1 to 26; k¹, k², k³ are independently from 0 to 6, provided k¹+k²+k³ is at least 2; and l¹, l², l³ are independently from 0 to 25.

8. An organic aerogel according to claim 1, wherein the ratio of the functional groups of the amine compound to the cyclic ether compound is 8:1.

9. An organic aerogel according to claim 1, wherein said organic aerogel has a solid content from 5 to 40%.

10. An organic aerogel according to claim 1, wherein said solvent is a polar solvent, preferably a polar aprotic solvent, selected from the group consisting of acetone, chloroform, dimethyl sulfoxide, dimethylacetamide, dimethyl formamide, 1-methyl-2-pyrrolidinone, acetonitrile, acetophenone, polypropylene carbonate water and mixtures thereof.

11. An organic aerogel according to claim 2, wherein said catalyst is selected from the group consisting alkyl amines, tertiary amines, hydroxyl containing compounds, imidazole compounds, aza compounds, preferably selected from a group consisting of 2,4,6-tris(dimethylaminomethyl)phenol, 2-ethyl-4-methylimidazole, triethanolamine, dimethylbenzylamine, 8-diazabycyclo[5.4.0]undec-7-ene, 1,4-diazabicyclo[2.2.2]octane and mixtures thereof.

12. A method for preparing an organic aerogel according to claim 1 comprising the steps of:
1) dissolving a cyclic ether compound into a solvent and adding an amine compound and mixing;
2) adding a catalyst, if needed, and mixing;
3) transferring the mixture of step 2) to a sealed mold;
4) heating or maintaining the solution in order to form a gel;
5) washing said gel with a solvent;
6) optionally, adding a silylation agent to the wet gel from step 5) and after reaction completion washing the gel with acetone;
7) drying said gel by
a) supercritical drying
or
b) ambient drying wherein, optionally, the CO₂ from the supercritical drying is recycled.

13. A method according to claim 12, wherein the temperature at step 4 to form a gel is applied from room temperature to 180° C.

14. A thermal insulating material or acoustic material comprising an organic aerogel according to claim 1.
